(19) United States
(12) Patent Application Publication
(10) Pub. No.: US 2025/0005668 A1
(43) Pub. Date: Jan. 2, 2025

(54) DECENTRALIZED AUTONOMOUS ORGANIZATION (DAO) FOR COST BASIS OPERATIONS

(71) Applicant: Mark MUELLER-EBERSTEIN, Bellevue, WA (US)

(72) Inventor: Mark MUELLER-EBERSTEIN, Bellevue, WA (US)

(21) Appl. No.: 18/215,677

(22) Filed: Jun. 28, 2023

(51) Int. Cl. G06Q 40/06; G06Q 30/0283

(52) U.S. Cl. CPC G06Q 40/06; G06Q 30/0283

(57) ABSTRACT

Techniques for a decentralized autonomous organization (DAO) platform that decentralizes generation of a financial report for cost basis operations. In one embodiment, the DAO platform may include one or more smart contracts that can define rules for filtering source or external data, processing of the external data to generate financial reports, storing of the financial reports in a blockchain, and/or authorizing a subscriber or an entity to access the financial reports. In this embodiment, subscriber approved one or more smart contracts may be leveraged to generate the financial reports that can be used by the subscriber or third parties such as a banking institution, tax agency, and the like.

### BACKGROUND

Enterprises such as exchange entities may handle a large number of financial transactions daily. As technology advances, cryptocurrency is being used increasingly, on and off the blockchain, as payment for goods and services for both domestic and international transfers, and in a new and evolving suite of protocols known as “Decentralized Finance” (DeFi) as “Non-Fungible Tokens” (NFTs), allowing complex transactions such as borrowing and lending, on-chain exchanges, and synthetic assets. Associated with the increasing use of cryptocurrency is a complicated calculation of tax liabilities and generation of financial reports for subscribers and/or government entities.

At present, the enterprises may need to use systems with high security, openness, and fairness when conducting internal management, such as voting and assessment systems. These systems are currently built on a client-server centralized system architecture scheme that lacks information storage security and data security. Accordingly, there is a need to provide a data processing apparatus to solve the problem of information storage security and data security in the currently built client-server centralized system architecture.

### BRIEF DESCRIPTION OF THE DRAWINGS

The detailed description is described with reference to the accompanying figures, in which the left-most digit(s) of a reference number identifies the figure in which the reference number first appears. The use of the same reference numbers in different figures indicates similar or identical items.

FIG. 1 illustrates an example architecture that implements a decentralized autonomous organization (DAO) for managing generation of financial reports, in accordance with at least one embodiment.

FIG. 2 is a block diagram for receiving and storing an internal representation of external data to a database, in accordance with at least one embodiment.

FIG. 3 is a block diagram for pre-processing transaction data to facilitate a generation of the financial reports, in accordance with at least one embodiment.

FIG. 4 is a block diagram of an example trade action that includes selling and buying of assets, in accordance with at least one embodiment.

FIG. 5 is a block diagram of a financial transaction processing center (FTPC) server that implements the generating of the financial reports, in accordance with at least one embodiment

FIG. 6 is a swimlane diagram illustrating an example cost basis calculation over financial transactions incurred by a subscriber in a tax year, in accordance with at least one embodiment.

FIG. 7 is a flow diagram of an example procedure for generating the financial reports, in accordance with at least one embodiment.

FIG. 8 is a flow diagram of an example procedure for improving a cost basis calculation based on atomic primitive operations, in accordance with at least one embodiment.

FIG. 9 is a flow diagram of an example procedure for using smart contracts to implement cost basis operations, in accordance with at least one embodiment.

### DETAILED DESCRIPTION

This disclosure is directed to a decentralized autonomous organization (DAO) that can manage a decentralization finance (DeFi) service such as, without limitation, a generation of a financial report for cost basis operations. In one embodiment, the DAO may be implemented via one or more smart contracts to manage the generation of the financial report for cost basis operations. A smart contract may include an automated piece of logic (i.e., a program) that is self-executing and stores state on a distributed ledger (of which a blockchain is one particular implementation of a distributed ledger). For example, the smart contract may utilize events from the DeFi service such as a filtering of external data and processing of the external data. In this example, one or more programs may perform the task of filtering and processing of the external data and thereafter, the events from the filtering and processing of the external data can be received by the smart contract. The smart contract may be configured to perform verifications of the received events, run programs that are triggered by the events, and post verified events or change of states in a blockchain platform e.g., Ethereum blockchain platform. In some embodiments, the smart contract may authorize a subscriber or an entity to access the stored states that may include the financial report for cost basis operations as described herein. In this embodiment, the smart contracts may be leveraged to manage the generation of the financial reports that can be used by the subscriber or a third party such as a banking institution, tax agency, another DAO, and the like. In some embodiments, such as in cryptocurrency applications, the smart contract may also use computing resources that need to be paid for with cryptocurrency. For example, a runtime may track an amount of compute resources and charges the user (usually the party that triggered the event) some cryptocurrency based on the compute resources. In this example, the cryptocurrency may be used to pay host services (e.g., Amazon Web Services or Microsoft Azure or the like) and the DAO that manages the DeFi service.

As described herein, and for simplicity of illustration, the smart contract may be also described to perform or facilitate performance of DeFi service processes (e.g., filtering of external data, querying, etc.) to generate the events and use the generated events to trigger event verification, execution of another program, and/or posting of output or states in the blockchain. Alternatively, or in addition, one or more programs in the DeFi service may be used to perform these tasks and communicate the generated events to the smart contract.

In one embodiment, the DAO, as an entity, may include a collectively owned, blockchain-governed organization where subscribers (or members) work towards a shared mission such as, for example, improving the generation of reports over executed buy/sell transactions for tax purposes. Here, the DAO entity has built-in treasuries that no subscriber or member has an authority to access without approval of the group. Decisions are governed by proposals and voting to ensure everyone in the organization has a voice and transactions happen transparently on-chain. With the use of the smart contracts, there is no requirement to trust a particular member in the organization. The smart contracts may be transparent and verifiable by the members of the DAO entity. While the smart contracts may also define token and stakeholder management for the DAO, or define DAO asset, portfolio, and liability management, the smart contracts as described herein may facilitate the management of the DeFi services for purposes, for example, of earning fees over transactions performed by the subscribers.

In some implementations, when managing the generating of the financial report, the (DAO) smart contract may facilitate generation and utilization of atomic primitive operations to determine a content of the financial report. The financial report may include a profit-and-loss (PnL) report, fees report, a debt report, or a holdings report. In this implementation, the smart contract may retrieve from a database corresponding transaction data that includes at least one action involving one or more assets from a blockchain-based financial transaction or off blockchain. The smart contract may then generate zero, one or more atomic primitive operations for the at least one action and use generated operation(s) to determine the content (e.g., taxable income, fees) of the financial report. In some examples, an action or actions may generate no operations on the asset, such as in the instance of a failed transaction, which may be represented by a transaction object containing an action that does not generate operations. In one instance, the generated one or more atomic primitive operations may be used to improve cost basis calculation for the at least one action by comparing results from different cost basis methods (e.g., first-in-first-out (FIFO) cost basis method, last-in-first-out (LIFO) cost basis method). The smart contract may then store the content into the database and/or blockchain, and transmit the content as, e.g., the financial report, formatted and unformatted “report data”, including as “Application Programming Interface” API call response to the subscriber or authorized entities such as the banking institution, tax agency, tax or accounting software, and the like.

As described herein, the action may include a transitioning of states by the asset in accordance, for example, with a smart contract protocol or workflow. The state may represent an instance while the transitioning of states can represent the atomic primitive operation(s) of the action where the instance can change its state. In one embodiment, the action involving one or more assets may include a trading action such as selling and buying assets, a discarding action such as donating the asset, a minting action such as mining or receiving an asset in an airdrop, a depositing or withdrawing action, a borrowing action, a payback action, an asset transfer-out action, and/or an asset transfer-in action. Here, the action may generate one or more atomic primitive operations, which can be representative of components of the action.

For example, the generated components (or atomic primitive operations) from the action may include a buying of an asset (referred to as a BuyOp), selling of the asset (referred to as SellOp), borrowing of the asset (referred to as BorrowOp), paying back of an account (referred to as PaybackOp), discarding of the asset as if nothing is received (referred to as DiscardOp), adjusting of cost basis (referred to as AdjustOp), earning or losing an amount (positive or negative) of a fiat reference currency (USD in this example) (referred to as USDEarnOp, representing a taxable gain (loss)), and/or receiving USD (referred to as USDReceiveOp, representing a non-taxable receipt of USD). Each of these components, or in combination with one or more different components, may be used to generate the content of the financial report. In one embodiment, the smart contract may perform a pre-processing of the transaction data in multiple passes that can include generation and matching of the atomic primitive operations regardless of type of requested report from the subscriber. In another embodiment, the smart contract may perform the pre-processing of the transaction data upon detection of a triggering event such as receiving of a new data upload or a subscriber request for a particular report. In some other embodiment, the smart contract may perform the pre-processing of the transaction data during a preconfigured interval such as every minute, hour, etc.

In one implementation, the smart contracts may include programs having rules and code logic that can be automatically executed. For example, to receive the financial data from the different external sources such as blockchain-based financial transactions (e.g., Ethereum, Bitcoin), exchange exported data (e.g., Coinbase), or customer-supplied data, the smart contract may use an open-source system such as an APACHE® KAFKA® to reliably receive and decouple financial or transaction data from the external heterogeneous sources. In this example, external data streams from the heterogeneous sources may be pushed into a streaming platform such as the APACHE® KAFKA®, and the external data streams can be decoupled and stored into the database without losing control of continuity of the external data streams in the streaming platform. The decoupled external data streams may be parsed and stored into the database as a non-relational document database that can provide support for JSON-like storage, or similar document-based non-relational management system e.g., MongoDB, MongoDB Atlas, or the like. Here, the stored transaction data may include a unified internal representation of the parsed financial data from the different external sources or data. The receiving, decoupling, and storing of the decoupled external data may include example terms of the contract that can be implemented by the smart contract.

In one embodiment, the smart contract may associate one or more atomic primitive operations to a particular stored transaction data based upon the metadata, and other details of the parsed transaction data to be stored in the database. For example, a trading action component-BuyOp may be associated by the smart contract to a particular stored transaction data when corresponding parsed external data (or trading action) shows decrease in a subscriber's dollar account and an increase in number of assets in between states. In another example, a trading action—SellOp may be associated by the smart contract to another stored transaction data when the corresponding parsed external data (or trading action) includes an increase in the subscriber's dollar account and a decrease in the number of assets during state transition, and so on. In these examples, the trading action may generate the associated atomic primitive operations that can represent financial activity of the subscriber. In another embodiment, the atomic primitive operations need not be initially associated during transaction data loading and the smart contract may request the trading action to generate the operations based on specified logic. In these embodiments, the stored transaction data may include the ID for the atomic primitive operations, transaction ID, source node ID, destination node ID, and the like.

With the stored transaction data, the smart contract may generate, for example, a subscriber requested financial report on the subscriber's latest blockchain-based financial transaction(s), such as buying and selling of a particular cryptocurrency (i.e., trading action) over a particular time period. The time period may include a previous hour, day, week, or any other period. In this example, the smart contract may query and retrieve the stored transaction data that correspond to the financial report to be generated. The retrieved transaction data may include at least one action that involves one or more assets from the blockchain-based transaction.

With the queried transaction data, the smart contract may then assign a value or price to the queried transaction data and particularly to the one or more assets that are involved in the action. The assigning of value or price may be based upon a price of the asset that participated in the action at the time of the transaction. In one embodiment, the smart contract may use a consistent and transparent centralized validation table of value to time when pricing or assigning values to the asset based upon the time of the transaction involving the asset. The centralized validation table may store prices of the assets at different time periods, different exchange sources, or a combination thereof, that can be used as a reference for the assigning of values to the asset.

For example, the centralized validation table may include information such as types and sources for the assets, transaction dates, and corresponding prices of the assets at the different transaction dates. Here, the prices of the assets at different transaction date may utilize the United States dollar (USD) as a base currency, by way of illustration only. Other fiat currencies may be utilized, as can cryptocurrency. In this example, the centralized validation table may provide a uniform price source for the assigning of values to the queried transaction data.

Following the assigning of values to the queried transaction data, the smart contract may then generate the atomic primitive operations for the one or more actions in the transaction data. In one embodiment, the smart contract may use the information recorded in the transaction data as well as additional information such as a locational jurisdiction of the subscriber for tax purposes, to generate preconfigured atomic primitive operations that can be representative of financial activities of actions in the queried transaction data. In this embodiment, the preconfigured atomic primitive operations in the database may include the AdjustOp, DiscardOp, and the like.

With the generated atomic primitive operations for the one or more actions in the transaction data, the smart contract may match the generated atomic primitive operation with another atomic primitive operation. Without limitation, the smart contract may use a table of preconfigured pairings as a reference for the matching. For example, the generated atomic primitive operations that can be matched with one another can include the pairings between the generated BuyOp and the generated SellOp: BorrowOp and the PaybackOp: BorrowOp and the SellOp: Buy Op and the PaybackOp: Buy Op and the DiscardOp: and the BorrowOp and the DiscardOp. In this example, the smart contract may allow matches only between “producing” operations (BuyOp and BorrowOp) and “consuming” operations (SellOp, PaybackOp and DiscardOp). For example, matching a SellOp with a PaybackOp is disallowed. USD operations such as the USDEarnOp and the USDReceiveOp may not be matched as described herein. Further, the AdjustOp, which is a “meta” operation that acts on the BuyOps and the SellOps to adjust cost basis or proceeds may not be matched with another atomic primitive operation.

For example, the associated atomic primitive operations from the queried transaction data may include a BuyOp on account of buying 10 ETH by the subscriber and a SellOp on account of selling 20 ETH by the subscriber within a particular time period. In this example, and based upon preconfigured pairing—references as enumerated above, the Buy Op may be matched with the SellOp. This pairing, for example, may be implemented to determine an income value between the trading action operation within the particular time period. Here, a particular action may generate the AdjustOp to adjust the cost basis in the Buy Ops or the proceeds in the SellOps. The action may link the AdjustOp to this trading action or can leave the trading action unlinked in which case the smart contract may again attempt to link the AdjustOp to the BuyOps and SellOps at a later stage of a pre-processing pipeline as described herein.

After the matching in the preceding example, the smart contract may repeat the matching step again using different cost basis methods (e.g. FIFO, LIFO etc.) to optimize or aim to optimize (e.g., within a tolerance), for example, the cost basis calculation for the queried transaction data. By determining and implementing the cost basis method that generates a favorable cost basis, the smart contract may be able to select the cost basis method to be applied to the determined income value to reduce the subscriber's taxable income.

In one embodiment, the value assignment and generation of the atomic primitive operations may be performed prior to receiving of the subscriber request or interaction with the user. In this embodiment, the smart contract may send notification alerts to the subscriber or user without initial interaction such as requesting for the financial report. Here, the pre-processing of the transaction data may reduce latency for the smart contract to show reports which the user may have subscribed to receive.

The techniques in the preceding example may be used to generate financial reports for the subscriber, for example expense report, profit report, fees report, holdings report, debt report, and the like, as well as financial insight reports as portfolio, holdings or airdrop reports. In order to generate the reports the smart contract may read and process the generated operations, potentially in the context of the actions that contain them. For example a profit report may subtract the proceeds recorded in SellOps from the basis recorded in BuyOps across all actions, whereas a debt report may query only debt actions to tally BorrowOps against PaybackOps contained in them, for example profit and loss. Further, the techniques in the preceding example may be implemented using subscriber approved DAO smart contracts which can include programs that can manage the receiving or filtering of external data, transforming and storing the external data to a particular format, retrieving transaction data, processing of the transaction data including the generating of the atomic primitive operations, and generating of the financial report by an authorized party or entity. Without limitation, the DAO smart contracts, in conjunction with a processor, may allow the smart contract to facilitate performance of the pre-processing continuously, within a regular predefined interval (e.g., every hour), or upon a detection of a triggering event such as the receiving of the subscriber request.

Some implementations and operations described herein may be ascribed to the use of a server; however, alternative implementations may execute certain operations in conjunction with or wholly within a different element or component of the system(s). In particular, in accordance with at least one embodiment, server functionality may be distributed across multiple computing devices including devices that do not primarily and/or typically act in the role of servers such as network edge devices. Further, some of the techniques described herein may be implemented in a number of contexts, and several example implementations and context are provided with reference to the figures. The term “techniques,” as used herein, may refer to system(s), method(s), computer-readable instruction(s), module(s), algorithms, hardware logic, and/or operation(s) as permitted by the context described above and throughout the document.

### Example Architecture

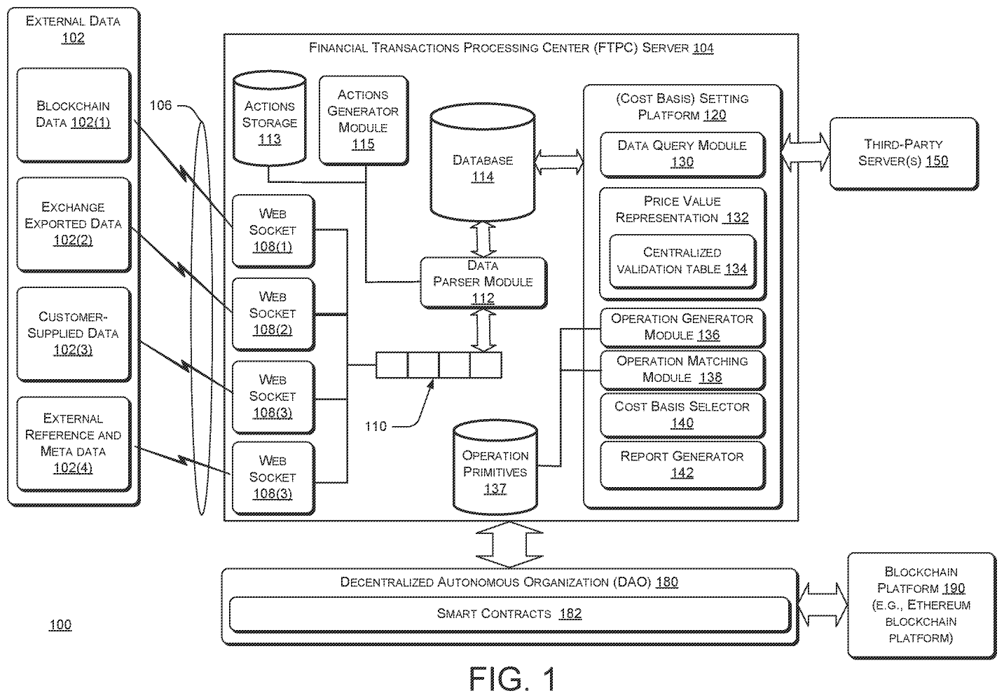

FIG. 1 illustrates a schematic view of an example computing architecture 100 that implements a decentralized autonomous organization (DAO) for managing the generating of a financial report that can be used by a subscriber. The DAO may utilize one or more smart contracts that can include programs or code logic to manage a DeFi service such as, without limitation, transactional cost basis operations. In one embodiment, one or more programs may be tasked to perform the generation of a financial report and thereby generate corresponding events over each step in a process of the generation of the financial report. In this embodiment, the smart contract may receive the corresponding events from the one or more programs and use the received events to perform a verification of the event, run another program, and/or trigger storing of states in a blockchain. In another embodiment, the one or more programs may be integrated into the smart contract and as such, the smart contract may be configured to perform the steps in the process of generating the financial report, generate corresponding events during the performance of the steps, and process the generated events. In these embodiments, and in cryptocurrency applications, the smart contract may use computing resources that need to be paid for with cryptocurrency. For example, a runtime may track an amount of compute resources and charges the user (usually the party that triggered the event) some cryptocurrency based on the compute resources. In this example, the DAO may use the cryptocurrency to pay host services (e.g., Amazon Web Services or Microsoft Azure or the like) and to pay the DAO as an entity for managing the flow, process, or operations of the DeFi service as described herein.

As shown, the computing architecture 100 may include external data 102 including, without limitation, blockchain data 102(1), exchange exported data 102(2), customer supplied data 102(3), and external reference and metadata 102(4). The external data 102(1)-102(4) may be connected to a financial transaction processing center (FTPC) server 104 through a network 106. The FTPC server 104 may include, for example, a decentralized and distributed platform for software applications that is immutable and supports consensus and transparency. The FTPC server 104 can also be operated or centrally managed by a third party such as a DAO 180 to provide financial reports to subscribers such as individual taxpayers or other entities. The DAO 180 may utilize one or more smart contracts 182 that may receive and process events from one or more programs that are tasked to operate the components or modules in the FTPC server 104 when receiving input data, processing output data, and sending notifications or alerts based on the output data. In some embodiments, the smart contracts 182 may include programs that are tasked to operate and/or control configurations of these components or modules. In these embodiments, the smart contracts 182 may post changes in state or store output data in a blockchain platform 190, which can propagate the posted changes in state or output data to local storages that are registered with the blockchain platform 190. Here, whenever a change in state or an event happens in a registered local storage of the FTPC server 104, the change in state or the event, via the blockchain platform 190, can be propagated to other registered local storages.

The FTPC server 104 may implement web sockets 108(1)-108(N), a receiving queue 110, a data parser module 112, database 114, and a (cost basis) setting platform 120 that further includes a data query module 130, a price value representation 132 with a centralized validation table 134, an operation generator module 136, an operation matching module 138, a cost basis selector 140, and a report generator 142. The setting platform 120 may be communicatively connected to a third-party server(s) 150 that can provide an additional source of external data. For illustration purposes, the setting platform 120 may be a cost basis setting platform that can facilitate a generation of cost basis financial report to the subscriber. Each component or module of the FTPC server 104 can be realized in hardware, software, or a combination thereof, where the function of each component or module can be implemented by programs that communicate events to the smart contracts 182 of the DAO 180. In some embodiments, the smart contracts 182 may include programs that are tasked to operate each of the module or component in the FTPC server 104. For example, the web-sockets 108(1)-108(4) may facilitate transfer of data from the external data 102 to the FTPC server 104. In this example, the smart contracts 182 may include programs or code logic that can define the external data 102 to be received, how the external data can be received via the web-sockets 108(1)-108(4), and storing of the external data in the database 114.

The external data 102 may include financial transaction data involving assets owned, purchased, sold, traded, received, given, or transacted to and by a subscriber (not shown) on a blockchain-based financial transaction or off a blockchain. The assets may include any other property that is quantifiable and associated with an economic value. In some examples, the assets may include digital assets or cryptocurrency, tokens, NFTs, or the like. The external data 102 may include external data that can be stored in the FTPC server 104 and further processed to generate a financial report(s) to a requesting subscriber. In some embodiments, the local storages that store the external data 102 may be registered with the blockchain platform 190. Here, the data updates or changes of state that are posted in the blockchain platform 190 may be propagated to the registered local storages.

Blockchain data 102(1) (e.g., Bitcoin, Ethereum, etc.) may include blockchain-based financial transaction data where the transaction data can be stored in blocks validated by participating nodes, linked to each other, thereby creating a chain of immutable interconnected data entries. Immutability in blockchain may mean that no information that is included in the data of the blocks can be changed without being detected. The information may be managed by a set of decentralized nodes, removing the need for a central authority to validate the transactions. In some instances, the blockchain data 102(1) may be a distributed ledger of transactions in chronological order, or may be presented in any order that may be suitable for use by a blockchain network. For example, the transactions recorded in the blockchain may include a destination address and a currency amount, such that the blockchain records how much currency is attributable to a specific address. Additional information may also be captured such as a source address, timestamp, and the like.

Exchange exported data 102(2) may include data from cryptocurrency exchange entities where coins such as Bitcoin, Ethereum, Solana, and the like, can be bought, sold, or traded. In one example, the exchange exported data 102(2) may include traded, bought, sold, staked, borrowed, lent, etc. cryptocurrency by the subscriber during a particular time period. In this example, the exchange exported data 102(2) that may be transmitted to the FTPC server 104 can include associated transaction fees and other fees that relate to the buying, selling, or swapping of the cryptocurrency. For clarity, the “Exchange” can be a centralized or decentralized entity and includes digital asset exchanges like Coinbase and Binance, but also decentralized exchanges (like Uniswap) or other entities like custody providers (e.g. BitGo), staking services, “Over the counter” (OTC) exchange providers etc.

Customer supplied data 102(3) may include financial transaction data from direct trading or personal transactions by the subscriber and can be directly transmitted to the FTPC server 104. The customer-supplied data 102(3) may also include financial data such as transaction fees, expenses, and other data that may be used in generating the financial report as described herein. In one example, the customer-supplied data 102(3) may include peer-to-peer (P2P) cryptocurrency trading, transaction fees and expenses associated with the P2P cryptocurrency trading, and the like. Another example of customer supplied data is “meta data” about specific wallets and exchanges. For example, this can include the “geographical” or “jurisdictional” location of a specific wallet or transaction or notes. Because there are many different ways a digital asset can enter or leave a digital asset wallet, each way may be identified, classified and stored as transaction information on the atomic level in the customer-supplied data to allow, e.g., accurate accounting treatment as described herein.

External reference and metadata 102(4) may include historical transaction or market prices such as prices of the assets at different time periods, different exchange sources, or a combination thereof, that can be used as a reference for the assigning of values to the asset; and other similar information.

The above examples of external data 102 are non-limiting and may include other financial transaction data from other external sources having trading platforms that can be linked to the FTPC server 104. One such example is a trading desk linking its trading platform to the FTPC server 104, allowing trades to be captured in the system as they occur.

The transaction data from each of the external data 102 may be received and stored by the FTPC server 104 via the network 106. The stored transaction data may include associated metadata such as, but not limited to, a subscriber ID, source ID, transaction ID, type of cryptocurrency, timestamps for each transaction, subscriber financial account ID, destination node ID, and other similar information. In one embodiment, the external data 102 may be continuously processed to generate output data that can include financial reports or financial report notification alerts that the subscriber subscribed to receive. In other embodiments, the pre-processing of the external data 102 may be triggered by a detection of an event such as receiving of a subscriber request or loading of new data. Alternatively, or additionally, the pre-processing of the external data 102 may be performed at a regular interval such as every minute, hour, etc.

The network 106 may be, without limitation, a local area network (“LAN”), a larger network such as a wide area network (“WAN”), a carrier network, or a collection of networks, such as the Internet. Protocols for network communication, such as TCP/IP, may be used to implement the network 106. The network 106 may provide telecommunication and data communication in accordance with one or more technical standards. While the third-party server(s) 150 are not shown to connect through the network 106, the FTPC server 104 may access the third-party server(s) 150 via the network 106 or other communication mediums.

Each one of the web-sockets 108(1)-108(4) may include an endpoint of a two-way communication link between two programs running on the network 106. The endpoint includes an Internet Protocol (IP) address and a port number that can function as a destination address of the web-socket. Each one of the web-sockets 108(1)-108(4) is bound to the IP address and the port number to enable external entities such as the blockchain data 102(1), exchange exported data 102(2), customer supplied data 102(3), and external reference and meta data 102(4) to communicate with the FTPC server 104. In one example, the web-sockets 108(1)-108(4) may be set up to receive external data streams from the blockchain data 102(1), exchange exported data 102(2), customer-supplied data 102(3), and external reference and meta data 102(4), respectively. The received external data streams may be pushed to the queue 110 before they are decoupled, via the data parser module 112, and stored into the database 114.

In one example, the decoupled external data streams may include the data streams that the database 114 has subscribed to receive via a publish/subscribe mechanism of the queue 110 (e.g., as provided by APACHE® KAFKA®). For example, the decoupled external data streams may include blockchain-based financial transaction data at a particular time period, type of cryptocurrency, subject of the transaction, or a combination thereof, for example. In this example, database 114 may subscribe to receive the external data streams via the queue 110. As described herein, the decoupling of the external data streams may include independently retrieving and processing the data streams without affecting the continuity or configuration of the external data streams that may be continuously received via the queue 110.

In one embodiment, the data parser module 112 may transform the decoupled external data streams to conform with a schema structure (e.g., JSON-like storage) of the database 114. The data parser module 112 may filter log entries, search for data and patterns in files of various data formats, convert log files from one data format to another data format such as the data format that is supported by MongoDB, and the like. In some instances, the data parser module 112 may identify details of the decoupled external data streams and can associate corresponding financial actions to the identified decoupled external data streams from the queue 110. The association may be based upon the details of the decoupled data streams that can include, without limitation, detected changes (deltas) in a subscriber's bank account or accounts managed directly on the blockchain by Decentralized Finance (“DeFi”) protocols, increase or decrease in the number of assets, asset identification, transaction IDs, source node IDs, destination node IDs, timestamps, ID for a type of transaction, identification of parties, and similar information. For example, a trade action may be associated with a parsed transaction data related to a detected decrease in a subscriber's dollar, stable coin, or token asset account and an increase in number of assets in between states. In this example, the state of the asset before and after transition may be used as a reference to generate, e.g., a BuyOp for the parsed transaction data. In another example, the trade action in the parsed transaction data may relate to a detected increase in a subscriber's dollar account and a decrease in number of assets in between states. In this other example, the state of the asset before and after the transition may be used as a reference to generate, e.g., a SellOp for the parsed transaction data.

In some implementations, the data parser module 112 may access an actions storage 113. The actions storage 113 may store data indicating the actions that the data parser module 112 may utilize to describe each identified transaction. The actions storage 113 may store data identifying the actions that are received from a user interacting with the FTPC 104 and/or from another computing device. For example, the actions storage 113 may store data identifying a trade action, a mint action, a burn action, and/or any other similar action. The actions storage 113 may store data identifying actions that are generated by actions generator module 115. The actions generator module 115 may be configured to generate the actions dynamically. The data parser module 112 may be parsing the data streams in the queue 110, identifying transactions in data streams in the queue 110, and attempting to assign actions to an identified transaction. The data parser module 112 may be unable to assign actions to an identified transaction. This may be because the transaction is a new type of transaction that has not yet been associated with one or more actions. In this case, the data parser module 112 may request that the actions generator module 115 generate new actions for the new type of transaction.

The database 114 may include a document-based non-relational database management system that can store the parsed transaction data via the data parser module 112. In one embodiment, the database 114 may include a non-relational document database that provides support for JSON-like storage. For example, the non-relational document database may store data objects in collections and documents instead of tables and rows in traditional relational databases. In this example, the collections may include sets of documents, which may be akin to tables in the relational database while the documents can consist of key-value pairs as the basic unit of data. For instance, for a particular transaction data, the database 114 may store the transaction ID which can be an action ID, associated atomic primitive operation ID, source ID, destination ID, subject of transaction ID, type of transaction ID, bank account ID, and the like. In this instance, the associated atomic primitive operation ID may be utilized by the FTPC server 104 as a reference to identify the atomic primitive operations to be generated and matched for purposes of generating the financial report as described herein. The FTPC server 104 may further utilize the associated atomic primitive operation ID to track the requested transaction data that can be processed to generate the financial report. In some instances, the atomic primitive operations need not be associated and the FTPC server 104 may generate the operations based upon specified logic of the queried transaction data.

The setting platform 120 may include an example application that processes the stored financial data in the database 114 to generate the financial report or financial report notification alert that the subscriber subscribed to receive. In one example, the setting platform 120 may generate the financial report that can be used to determine a favorable taxable income for the subscriber. In this example, and to generate the financial report, the setting platform 120 may be configured to perform the querying of stored financial transactions in the database 114 and processing of the queried financial transaction data to generate the content for the financial report.

In one example, the setting platform 120 may facilitate the matching between the generated atomic primitive operations, application of atomic primitive operations such as an application of the AdjustOp to the BuyOps to calculate the cost basis, or a combination thereof, to generate the financial report. In this example, the setting platform 120 may decompose an action into pre-established atomic primitive operations (e.g., financial primitives) and implement matching of the atomic primitive operations across the appropriate actions for every asset related to the queried transaction data. That is, operations may be generated and matched by the setting platform 120 irrespectively of which report is requested. For example, the smart contract may match “producing” operations such as BuyOp or BorrowOp with “consuming” operations, such as SellOp, PaybackOp, or DiscardOp. USD operations such as USDEarnOp and USDReceiveOp are not generally appropriate to match. AdjustOp can be considered a “meta” operation (e.g., acting on BuyOps and SellOps) and would generally not be matched. By way of illustration, the generating of reports such as a sales profit and loss (PnL) report can be facilitated by scanning SellOps, checking corresponding matching BuyOps, and subtracting the cost basis (stored in the BuyOps) from the proceeds (stored in the SellOps), for example.

The data query module 130 may include an application that can retrieve the corresponding financial transaction data from the database 114. The querying and retrieval may be performed continuously, over a periodic interval, or upon a triggering event such as the receiving of the subscriber request. The continuous retrieval and pre-processing of the retrieved transaction data may be implemented to send notification alerts without initial or received interactions from the subscriber. In some cases, the retrieved transaction data may be defined by parameters of the notification alerts that the subscriber has subscribed to receive. For example, the parameters can include every transaction action, the transaction actions entered into by the subscriber over a particular period, type or subject of the transaction action, source of external data, or a combination thereof.

With the queried financial transaction data, the price value representation 132 may be configured to assign prices or values to the queried financial transaction data and particularly to the one or more assets that are involved in the action in the queried financial transaction data. In one example, the database 114 may store the timestamps or time of transactions involving the one or more assets in the queried transaction data. In this example, the assigning of values may be based upon the prices of the assets at the time of the transaction such as at the time of buying of the asset, selling of the asset, and the like.

In one embodiment, the price value representation 132 may provide a consistent and transparent centralized validation table of value to time that can be used as a reference when assigning prices to the assets that are involved in the action. The centralized validation table 134 may store key-value pairs of prices for different types of assets at different time periods and US dollar (or other reference fiat currency or token) exchange rate at the different time periods, for example. The stored information in the centralized validation table 134 may be utilized to provide consistent pricing of the assets involved in the action at the time of the transaction. For example, a trade action from the queried transaction data may involve an asset that was sold on Jan. 10, 2022. In this example, the centralized validation table 134 may be used to determine the value of the asset at that time, i.e., on Jan. 10, 2022.

The operation generator module 136 may be configured to generate the atomic primitive operations that can be used to generate the content for the financial reports. In one embodiment, the atomic primitive operations may by generated from the action or actions that are associated with the queried financial transaction data. The generated atomic primitive operations may include the buying of an asset operation (referred to as a BuyOp), selling of the asset (referred to as a SellOp), borrowing of the asset (referred to as a BorrowOp), paying back debt in an account (referred to as a PaybackOp), discarding of the asset as if nothing is received (referred to as a DiscardOp), adjusting of cost basis or sale proceeds (referred to as an AdjustOp), earning or losing an amount (positive or negative) of a fiat reference currency (USD in this example) (referred to as USDEarnOp, representing a taxable gain (loss)), and/or receiving USD (referred to as USDReceiveOp, representing a non-taxable receipt of USD). Here, the operation generator module 136 may apply preconfigured rules corresponding to financial semantics or specified logic of the actions associated the transaction data to identify the atomic primitive operations to be generated. For example, a DebtAction that may represent borrowing by a subscriber may generate a Borrow Op that can be used as a reference to facilitate generation of a debt report. In this example, and in a case where the subscriber executed a short sale, the generated BorrowOp can be matched with the SellOp and this link can facilitate the generation of the PnL report.

With the generated one or more atomic primitive operations, the setting platform 120 may identify the generated atomic primitive operation(s) that can be matched with another atomic primitive operation(s), linked with another operation(s), or a combination thereof. In identifying the matching pairs, for example, the operation matching module 138 may store a table of preconfigured pairs of matching atomic primitive operations such as between the generated BuyOp and the generated SellOp: BorrowOp and the PaybackOp: BorrowOp and the SellOp: Buy Op and the PaybackOp: Buy Op and the DiscardOp: and the associated BorrowOp and the associated DiscardOp. Each of these pairings may be retrieved from the table (not shown) and used as a reference when identifying the generated atomic primitive operations to be matched or linked with one another.

For example, a SellOp and a Buy Op may be generated from the action that is associated with a queried trading action. Based on the stored preconfigured pairings, the SellOp and the BuyOp may be matched and associated with the trading action in the database 114. Further, the AdjustOp may be applied to the Buy Op and the SellOp to adjust cost basis and proceeds, respectively. In this example, the link between the AdjustOp and the Buy Op/SellOp may be stored in the database 114 to allow tracing back of original (or unadjusted cost or proceeds) to justify the adjusted cost basis or proceeds. In one instance, the AdjustOp from a FeeAction (or fee payment action) may be linked to the BuyOp. In this case, the paid fees for the FeeAction may be used as a reference to justify the adjusted cost basis of the BuyOp. The links between the Buy Ops and the SellOps (on one side) to the AdjustOps (on the other side) may be many-to-many i.e., a single BuyOp or SellOp can be adjusted multiple times by linking it to multiple AdjustOps, and one AdjustOp can adjust multiple Buy Ops and/or SellOps.

The operation generator module 136 may store the operation primitives in operation primitives storage 137. In some implementations, the operation generator module 136 may generate additional operation primitives and store those operation primitives in the operation primitives storage 137. The operation generator module 136 may initiate generation of additional operation primitives in response to a request from the data parser module 112. The data parser module 112 may indicate that the data parser module 112 identified a new transaction. In response to receiving this indication, the operation matching module 138 may determine whether there are operation primitives in the operation primitives storage 137 that may represent the new transaction. The operation matching module 138 may determine that the operation primitives storage 137 includes operation primitives that represent the new transaction. If the operation matching module 138 determines that the operation primitives storage 137 does not include operation primitives that represent the new transaction, then the operation matching module 138 may request that the operation generator module 136 generate additional operation primitives that represent, possibly in part with existing operation primitives, the new transaction. In some implementations, the operation generator module 136 may generate the new operation primitives based on input received from a user and/or another computing device. In some implementations, the operations generator module 136 may generate the new operation primitives without input.

In the preceding example, the cost basis selector 140 may include an example application that facilitates an adjustment in cost basis or proceeds in the trading action and further link the adjustment operation (AdjustOp) to the BuyOp/SellOp components of the trading action. Further, the cost basis selector 140 may facilitate a determination of an optimal adjusted cost basis to utilize that is favorable to the subscriber. For example, the cost basis selector 140 may determine an optimal (or near-optimal) assignment of asset lots for specific identification on every sale operation. In another example, the cost basis selector 140 may determine or calculate the adjusted cost basis for each of the FIFO, LIFO, and other cost basis methods, compare the determined adjusted cost basis from each of these cost basis methods, and select the cost basis method that can generate the optimal adjusted cost basis that is favorable to the subscriber. The optimal adjusted cost basis may include the adjusted cost basis that generates a minimum taxable income.

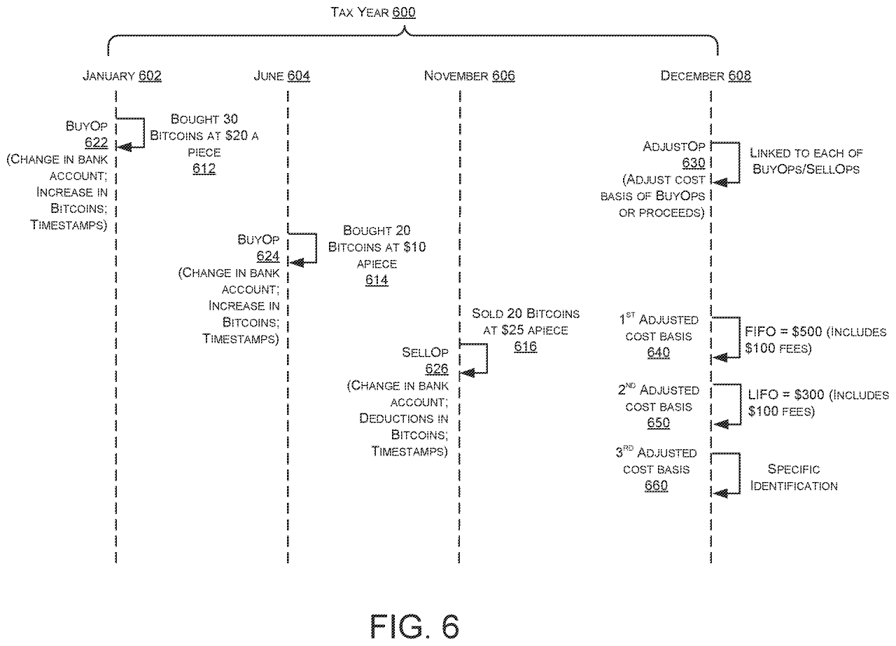

The FIFO cost basis method may include an asset-management and valuation method in which assets produced or acquired first are sold, used, or disposed of first. For tax or financial accounting purposes, the FIFO cost basis method assumes that assets with the oldest costs are included in the income statement's cost of goods sold (COGS). The remaining inventory assets may be matched to the assets that are most recently purchased or produced. Here, the generated atomic primitive operations may be located in a data structure that is defined by the implementation of the FIFO cost basis method. On the other hand, the LIFO cost basis method is an accounting method in which assets purchased or acquired last are disposed of first. The FIFO and LIFO cost basis methods are further illustrated in detail in FIG. 6 below.

While the financial reporting in the preceding example is based upon the matching between the BuyOp and the SellOp, other types of matchings may be applied to generate the financial report. As one, non-limiting example, a pairing between an associated BorrowOp and DiscardOp may be used as a reference to generate accrued interest.

The report generator 142 may generate a financial report or financial report notification alert to the subscriber upon the processing of the transaction data. In one example, the financial report may include a profit and loss statement, fees report, debt report, holdings report, and the like. Entries in the report(s) may be taken from the results of the actions described herein.

The third-party server(s) 150 may provide additional sources of external data that can be retrieved and/or processed as described above. In some cases, the third-party server(s) 150 may provide an additional database similar to the database 114 in the FTPC server 104.

In some embodiments, the DAO 180 may include a data processing apparatus that can be applied to a distributed network to ensure data security of the decentralized autonomous organization. The DAO 180 may include the smart contracts 182 that can support DeFi services such as, without limitation, versioning processes, matching algorithms, reporting, blockchains to support, consensus algorithms, data model structures, wallets, services to interface, names of things, internationalization support, audit train management, accelerator model (jurisdiction) and UI/UX change. The smart contracts 182 may further support stakeholder management such as, without limitation, new stakeholders, stakeholders to be evicted, stakeholders leave, or stakeholder delegates. Further, the smart contracts 182 may support token management such as distribution of tokens, issuing tokens, or burning of tokens. Further, the smart contracts 182 may support asset/liability management such as paying contributions, managing intellectual property, and hosting. Also, smart contracts 182 may include legal resolution structure such as operating agreement and lawsuit management. Smart contracts 182 may also include code logic to implement voting to terminate, voting to liquidate, preservation of records, ownership of records, and the like.

In one embodiment, the smart contracts 182 may include programs or code logic to receive and process events, or to perform the transactional cost basis operations as described in the FTPC server 104. In this embodiment, smart contracts may 182 be deployed and executed in an Ethereum blockchain platform 190, for example. In this example, the Ethereum blockchain platform 190 may include an example public blockchain that is permissionless.

The blockchain platform 190 may include a globally shared transactional database that is updated and shared across many local storages and/or devices in a network. In one example, the blockchain platform 190 may store the changes in state, events, data updates, and/or generated contents of the financial reports as described above.

### Example Processing Flow for Storing of External Data to the Database

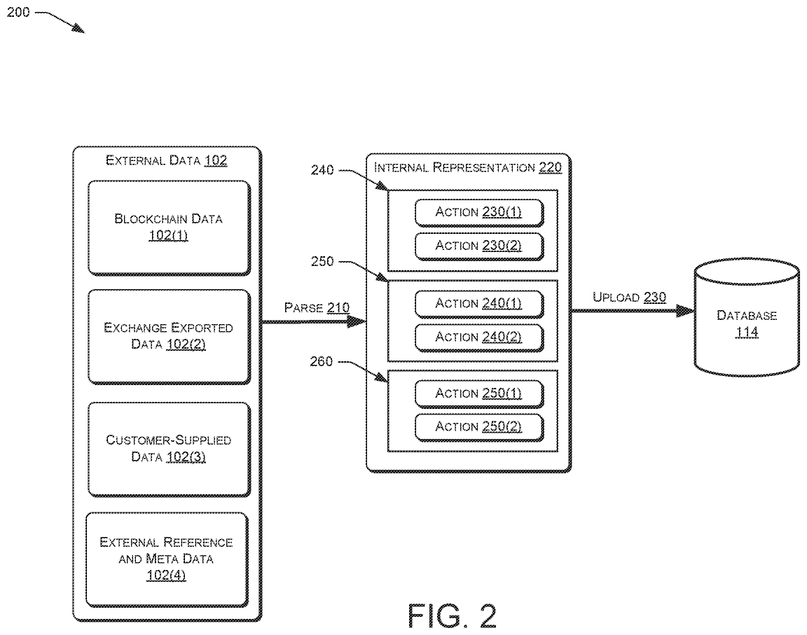

FIG. 2 illustrates a block diagram 200 that shows a receiving and storing of an internal representation of the external data 102 to the database 114. The block diagram 200 may be implemented by the FTPC server 104 in FIG. 1 and particularly, by the data parser module 112. Further, the receiving and storing of the external data 102 in the block diagram 200 may generate events that are received and processed by the smart contracts 182 of FIG. 1. Alternatively, or additionally, the smart contracts 182 of FIG. 1 may run programs that performs the receiving and storing of the external data 102 in the diagram 200.

In one embodiment, the data parser module 112 may parse 210 the external data 102 to generate an internal representation 220 of the received external data or financial data transactions from the different sources or exchanges. Upon parsing of the external data 102, the FTPC server 104 may further upload 230 the derived internal representation 220 as transaction data to the database 114.

For example, data parser module 112 may transform the blockchain data 102(1), exchange exported data 102(2), customer-supplied data 102(3), and/or external reference and meta data 102(4) to conform with a schema structure (e.g., JSON-like storage) of the database 114. In this example, the data parser module 112 may filter log entries, search for data and patterns in files of various data formats, and/or convert log files from one data format to another data format such as the data format that is supported by MongoDB or similar centralized or decentralized databases. In one instance, the internal representation 220 may include a first transaction 240 with associated actions 240(1)(2), a second transaction 250 with associated actions 250(1)(2), and a third transaction 260 with associated actions 260(1)(2). Each of the first transaction 240, second transaction 250, and the third transaction 260 may include metadata such as transaction data ID, timestamps for their respective actions, source ID, destination ID, ID for associated atomic primitive operations, and the like.

In one embodiment, each of the actions in the internal representation 220 may include one of a trading action such as selling and buying assets, a discarding action such as donating the asset, a minting action such as receiving an airdropped asset, a depositing or withdrawing action (to/from an account), debt action such as borrowing or paying back an asset, fee action representing fees incurred during a financial activity (e.g., trading fees), asset transfer action representing sending or receiving an asset (such as between a company's own subsidiaries), and the like. Further, each of these actions may be further decomposed into one or more atomic primitive operations, which can be representative of the generated components of the action.

In an embodiment, the uploading of the internal representation 220 may include storing of the transaction data in a particular format such as that of MongoDB which stores data in BSON format. In this embodiment, the database 114 may include a document-based non-relational database management system that can store the uploaded internal representation 220 in the desired particular format. For example, the database 114 may store data objects in collections and documents instead of tables and rows in traditional relational databases. In this example, the collections may include sets of documents, which may be akin to tables in the relational database while the documents can consist of key-value pairs as the basic unit of data. In one instance, and for a particular transaction data, the database 114 may store the transaction ID, associated atomic primitive operation ID, source ID, destination ID, subject of transaction ID, type of transaction ID, bank account ID, and the like.

In some embodiments, the parsing and uploading of the internal representation 220 in the database 114 may be implemented by the programs and code logic in the smart contracts. In one example, a corresponding smart contract may implement the parsing and loading of the internal representation 220, respectively. In another example, a single smart contract may implement the parsing and the loading of the internal representation 220. In these examples, the one or more smart contracts may include programs that can perform the receiving, parsing, and uploading in the block diagram 200. Alternatively, or additionally, the one or more smart contracts may receive events from each step in the block diagram 200 and use the received events to perform another program, verification, or trigger uploading of states in the blockchain platform 190.

### Example Processing Flow for Generating the Financial Report

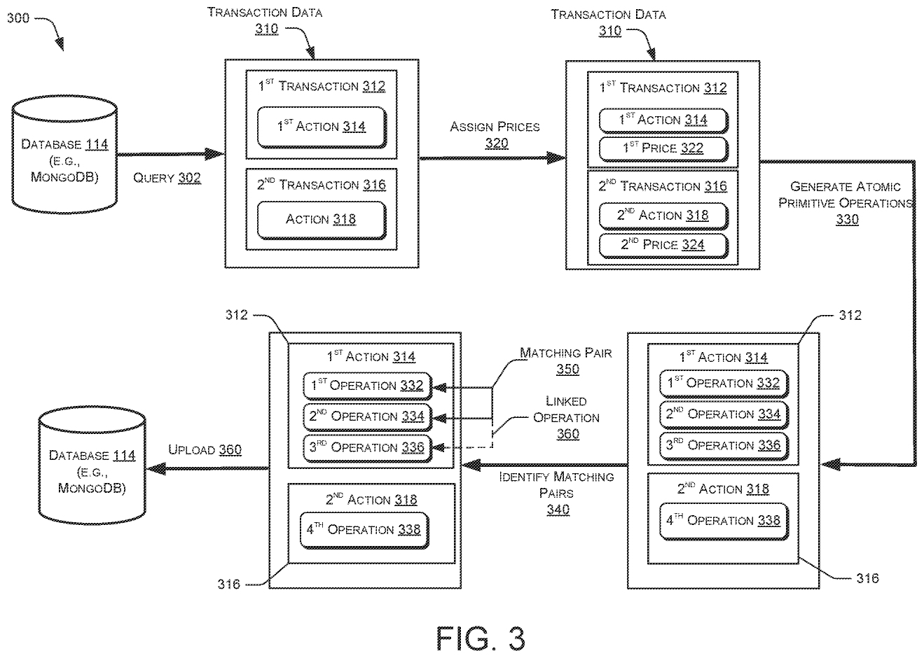

FIG. 3 illustrates a block diagram 300 that shows an example implementation for pre-processing transaction data to facilitate generation of a report. In one embodiment, the pre-processing of the transaction data may be made in multiple passes to construct an accurate model of a financial state of the subscriber at different periods. Here, the atomic primitive operations may be generated and matched regardless of type of report to be requested or generated for the subscriber. In another embodiment, the pre-processing of the transaction data may be triggered by an event such as receiving of a subscriber request for a particular report. For purposes of illustration, the discussion below facilitates the generation of the report in response to a subscriber request for a calculation of the taxable income over a particular action such as a trading action. Further, the steps and/or processes performed by each block in block diagram 300 may be facilitated by the smart contracts 182 of FIG. 1. For example, the smart contracts 182 may include one or more programs to perform the step of querying, assigning of prices, and the like. Alternatively, or additionally, the one or more smart contracts may receive events from each step in the block diagram 300 and use the received events to perform another program, verification, or trigger uploading of states in the blockchain platform 190.

In one embodiment, the FTPC server 104 may perform a query 302 on the database 114 to retrieve transaction data 310, which includes a first transaction 312, a first action 314, a second transaction 316, and a second action 318. For example, the first action 314 and the second action 318 may include a trading action and a burn action, respectively. The burn action may include disposing of the asset without consideration e.g., donation. In this example, the first transaction 312 and the second transaction 316 may include metadata and other information of the first action 314 and the second action 318, respectively.

The FTPC server 104 may then assign prices 320 to the first action 314 and the second action 318. Particularly, prices or values are assigned over the assets that are involved in the first action 314 and the second action 318. Here, a first price 322 may include the assigned value of the involved assets in the first action 314 at the time of the corresponding transaction while a second price 324 may include the assigned value of the involved assets in the second action 318 at the time of the corresponding transaction.

With the assigned prices to each asset in the transaction data 310, the FTPC server 104 may generate atomic primitive operations 330 from the corresponding actions in the retrieved transaction data 310. In one embodiment, the generated atomic primitive operations may be taken from the associated atomic primitive operations in the queried transaction data, referenced from stored preconfigured atomic primitive operations such as an adjusting operation (AdjustOp), or a combination thereof. For example, the first action 314 may be associated with a generated first atomic primitive operation 332 (BuyOp), second atomic primitive operation 334 (SellOp), and a third atomic primitive operation 336 (AdjustOp) while the second action 318 can be associated with a generated fourth atomic primitive operation 338 (DiscardOp). In this example, the first atomic primitive operation 332 (BuyOp), second atomic primitive operation 334 (SellOp), and the third atomic primitive operation 336 (AdjustOp) may be among the atomic primitive operations that are generated to effect the first action 314 on the queried transaction data 310 while the generated fourth atomic primitive operation 338 (DiscardOp) can be generated to effect the second action 318. In some embodiments, the first atomic primitive operation 332 (BuyOp) and the second atomic primitive operation 334 (SellOp) may be referenced from the atomic primitive operations that are associated from the queried transaction data 310 while the third atomic primitive operation 336 (AdjustUp) and the fourth atomic primitive operations 338 (DiscardOp) can be referenced from the stored preconfigured set of atomic primitive operations.

In one embodiment, the FTPC server 104 may use the table of preconfigure matching in the operation matching module 138 to identify matching pairs 340 among the generated atomic primitive operations in the first action 314, second action 318, or a combination thereof. For example, to calculate the taxable net income for the trading action, a matching pair 350 is representative of the matching between the first atomic primitive operation 332 (BuyOp) and the second atomic primitive operation 334 (SellOp) to generate an income value. In this example, a linked operation 360 may indicate the linking of the third atomic primitive operation 336 (AdjustOp) to adjust the cost basis and the proceeds for first atomic primitive operation 332 (BuyOp) and the second atomic primitive operation 334 (SellOp), respectively. With this adjustment, the linked operation 360 may facilitate the calculation of the taxable net income for the trading action (first action 314).

In one example, the location of the first atomic primitive operation 332 (BuyOp) and the second atomic primitive operation 334 (SellOp) in the data structure may be determined in accordance with the cost basis method (e.g., FIFO) that is currently being applied to determine the taxable income. In some cases, a specific identification method may be used to identify the assets and/or operations to be used in calculating the taxable income. For example, the specific identification method may be used to find an optimal or near optimal assignment of asset lots on every sale.

With the calculated taxable income in the preceding example, the FTPC 104 may upload 360 the results of the matching operations to the database 114. For example, the results may include the calculated taxable income for the first action 314 (trade action) and the amount and value of the lost asset in the second action 318 (burn action). In this example, the results may be included in the content of the financial report to be sent to the subscriber.

In some embodiments, the query 302, assignment of prices 320, generation of atomic primitive operations 330, identification of matching pairs 340, and the upload 360 may be implemented via the execution of the smart contracts 182 of FIG. 1. For example, the smart contracts 182 may implement the querying, assigning of prices, generating of the atomic primitive operations, matching, and uploading of the content of the financial report to the database 114. In some embodiments, the smart contracts 182 may also upload the content of the financial report to the blockchain platform 190. Alternatively, or additionally, the smart contracts 182 may receive events from each step in the block diagram 300 and use the received events to perform another program, verification, or trigger uploading of states in the blockchain platform 190.

Example Action Involving Assets from Blockchain-Based—Financial Transactions

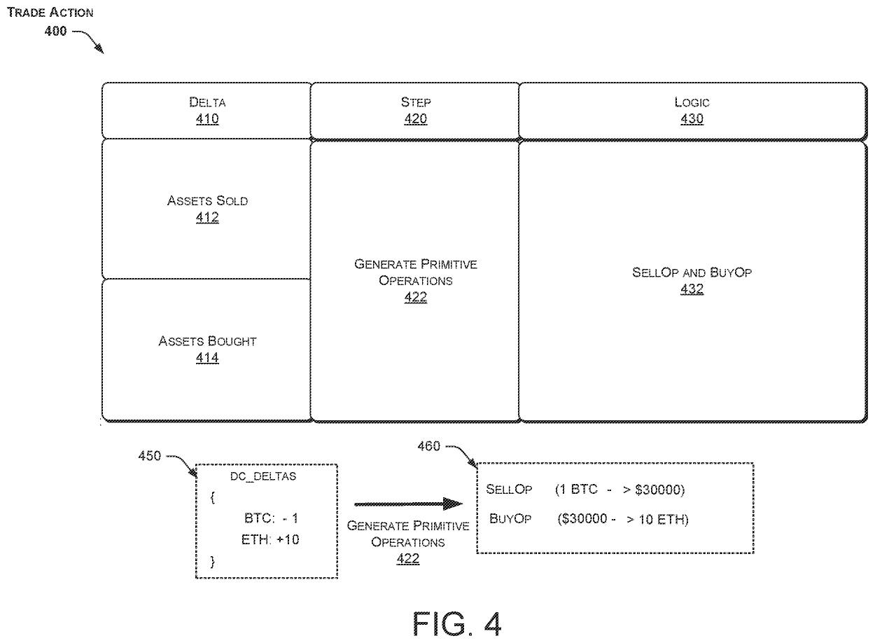

FIG. 4 illustrates a block diagram of an example trade action 400 that includes selling and buying of assets over a particular time period. As shown, the trade action 400 may include a delta 410 that represents changes in assets sold 412 and assets bought 414, a step 420, and a logic 430. The step 420 may represent the pre-processing from the storing of the transaction data to the matching process to generate the financial report as described in FIG. 3 above. In order to generate the atomic primitive operations, the FTPC server 104 may make multiple passes over the same transactions in order to construct an accurate model of the financial state of the subscriber at different points in time.

In one example, the trading action 400 may include selling 1 Bitcoin for $30,000 and buying 10 ETH for $30,000 as shown in representative block 450. Here, the step 420 for the trade action 400 may generate primitive operations 422 that can include BuyOps and SellOps, which are represented by block 432. These atomic primitive operations may be derived from the details of the assets sold 412 and the assets bought 414. In this example, the trading action 400 may generate the SellOp and BuyOp as shown in representative block 460. The generated atomic primitive operations in the representative block 460 may be combined (i.e., selling price minus buying price) to generate a gross income, for example. In this example, another atomic primitive operation such as the AdjustOp may be generated and linked to adjust the cost basis and the proceeds for the BuyOp and the SellOp, respectively, in the trading action 400.

The trade action 400 is for illustration purposes only and other, different actions as described herein may involve corresponding changes in the delta 410 and generated primitive operations 422.

For example, a mint action (not shown) may correspond to an increase in an asset's balance indicated by a positive delta 410. The positive changes may represent earnings via mining, validator income, airdrops, or yield generation. In this example, the generated atomic primitive operations may include USDEarnOp and/or BuyOp (e.g., with a pre-adjusted cost basis of $0).

For another example, a burn action (not shown) may correspond to a decrease in an asset's balance indicated by a negative delta 410. The negative changes may represent irrevocable loss of an asset. In this example, the generated atomic primitive operations may include SellOp with zero proceeds or USDEarnOp, which can be an atomic primitive operation indicating a gain or loss of USD and should be treated as a tax event).

For example, the burn action/discard (not shown) may correspond to a decrease in an asset's balance indicated by a negative delta 410. The negative changes may represent the disposition of the asset without consideration. In this example, the generated atomic primitive operations may include DiscardOp.

For example, a fee action (not shown) may correspond to a decrease in asset balances indicated by a negative delta 410. The negative changes may represent payment of a transaction fee. In this example, the generated atomic primitive operations may include DiscardOp and AdjustOP, and so on.

### Example FTPC Server

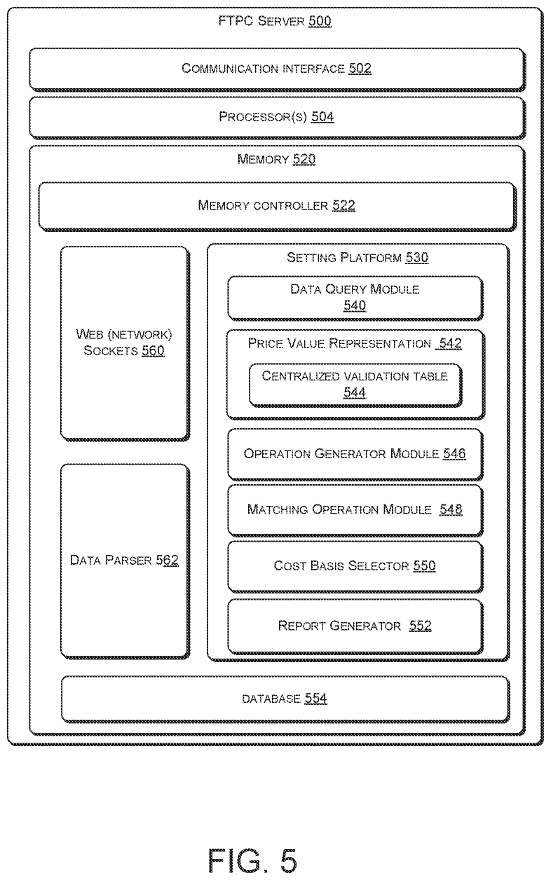

FIG. 5 is a block diagram of an example FTPC server 500 that implements, for example, the improving of the cost basis calculation based on atomic primitive operations. The FTPC server 500, which may be similar to the FTPC server 104 of FIG. 1, may include a computer system that receives external data, processes the received external data, and generates a financial report or financial report notification alert to the subscriber. In one embodiment, the FTPC server 500 may be centrally managed by the smart contracts 182 of FIG. 1. For example, the smart contracts 182 may receive events from the FTPC server 500 and use the received events to perform another program, verification, or trigger uploading of states in the blockchain platform 190. Alternatively, or additionally, the smart contracts 182 may include programs to configure the FTPC server 500. In this case, the smart contracts 182 may include programs that can generate the events, process the generated events, and output data to be stored in the blockchain platform 190.

The FTPC server 500 may include a communication interface 502 that facilitates communication with the external data 102 and the DAO 180. Communication between the FTPC server 500 and other electronic devices may utilize any suitable sort of communication protocol for sending and receiving data and/or voice communications.

The FTPC server 500 may further include a processor 504 having electronic circuitry that executes instruction code segments by performing basic arithmetic, logical, control, memory, and input/output (I/O) operations specified by the instruction code. The processor 504 can be a product that is commercially available through companies such as Intel® or AMD®, or it can be customized to work with and control a particular system. The processor 504 may be coupled to other hardware components used to carry out device operations. The other hardware components may include one or more user interface hardware components not shown individually—such as a keyboard, a mouse, a display, a microphone, a camera, and/or the like—that support user interaction with the FTPC server 500.

The FTPC server 500 also may include memory 520 that stores data, executable instructions, modules, components, data structures, etc. The memory 520 may be implemented using computer-readable media. Computer-readable media includes, at least, two types of computer-readable media, namely computer-readable storage media and communications media. Computer-readable storage media includes, but is not limited to, Random Access Memory (RAM), Dynamic Random Access Memory (DRAM), Read-Only Memory (ROM), Electrically Erasable Programmable Read-Only Memory (EEPROM), flash memory or other memory technology, Compact Disc-Read-Only Memory (CD-ROM), digital versatile disks (DVD), high-definition multimedia/data storage disks, or other optical storage, magnetic cassettes, magnetic tape, magnetic disk storage or other magnetic storage devices, or any other non-transmission medium that can be used to store information for access by a computing device. As defined herein, computer-readable storage media do not consist of and are not formed exclusively by modulated data signals, such as a carrier wave. In contrast, communication media may embody computer-readable instructions, data structures, program modules, or other data in a modulated data signal, such as a carrier wave, or other transmission mechanisms.

A memory controller 522 may be stored in memory 520 of the FTPC server 500. The memory controller 522 may include hardware, software, or a combination thereof, that enables the memory 520 to interact with the communication interface 502, processor 504, and other components of the FTPC server 500. For example, the memory controller 522 may receive external data streams from the communication interface 502 and facilitate storing of the received external data streams in memory 520. In another example, the memory controller 522 may retrieve data streams from memory 520 and the retrieved data streams can be processed in the processor 504.

The memory 520 may include a cost basis setting platform 530 that, when executed, implements the optimization of the cost basis calculation based on atomic primitive operations. As shown, the cost basis setting platform 530 may further include a data query module 540, price value representation 542 with a centralized validation table 544, an operation generator module 546, a matching operation module 548, a cost basis selector 550, and a report generator 552 that may respectively correspond to the cost basis setting platform 120, data query module 130, price value representation 132, centralized validation table 134, operation generator module 136, matching operation module 138, cost basis selector 140, and the report generator 142 of FIG. 1.

The memory 520 may further store and/or implement, at least in part, web-sockets 560, a data parser 562, and a database 570 that may respectively correspond to the web sockets 108, data parser module 112, and the database 114 of FIG. 1. In one example, each component of the memory 520 can be realized in hardware, software, or a combination thereof.

The web-sockets 544 may be implemented by a software module designed to establish communications with the external data 102. In one example, each of the web-sockets 544 is bound to the IP address and the port number to communicate with the corresponding external data source.

In one example, the data parser 562 may include an application programming interface (API) to establish a connection with the event streaming platform. The cost basis setting platform 530 of the FTPC server 500 may subscribe to blockchain data in the event streaming platform and utilize the data parser 562 to facilitate the storing of the blockchain data to the database 554. In this example, the blockchain data may be stored as a non-relational document database that can provide support for JSON-like storage, or similar document-based non-relational management system.

The FTPC server 500 may use the communication interface 502 to transmit financial report notification alert or receive a subscriber request. Here, the cost basis setting platform 530 may use the data query module 540 to query the transaction data when new external data is stored, continuously to generate the financial report notification alert to the subscriber, or upon receiving of a subscriber request. Upon retrieving of the transaction data, the cost basis setting platform 530 may utilize the price value representation 542 to assign price or pecuniary values to the assets that are involved in the action.

Similar to the discussion in FIGS. 1 and 3 above, the cost basis setting platform 530 may then use the operation generator module 546 to generate the atomic primitive operations, match the generated atomic primitive operations, and use at least the matched atomic primitive operations to generate the content for the financial report.

In some embodiments, each module or component in the FTPC server 500 may be centrally managed via the use of the one or more smart contracts in the DAO such as the DAO 180 of FIG. 1. For example, the FTPC server 500, via or based on the one or more smart contracts, may implement the steps of receiving external data, filtering external data, transforming, and storing of the decoupled external data, and so on. In this example, the smart contracts may include preconfigured programs that automatically run in the blockchain unless otherwise changed via voting of the DAO members.

### Example Cost Basis Calculation

FIG. 6 is a swimlane diagram illustrating an example cost basis calculation over financial transactions (or trading actions) incurred by a subscriber in a tax year. Each step or process in the example cost basis calculation may be facilitated by executing programs (or smart contracts) in the blockchain. In the example shown, a tax year 600 is a calendar year during which corresponding financial transactions were incurred by the subscriber. First, in January 602, the subscriber bought 30 Bitcoins at $20 apiece 612. In June 604, the subscriber bought 20 Bitcoins at $10 apiece 614. Then, in November 606, the subscriber sold 20 Bitcoins at $25 apiece 616. As illustrated, the financial transactions over January 602, June 604, and November 606 may correspond to the atomic primitive operations BuyOp 622, BuyOp 624, and SellOp 626, respectively. An AdjustOp 630 may be applied to each of these atomic primitive operations BuyOp 622, BuyOp 624, and SellOp 626 to adjust the cost basis for BuyOp and proceeds for the SellOp (e.g., to account for trading fees). Thereafter, an adjusted cost basis that may generate a minimum taxable income can be selected for income tax filing, for example.

In one example, the trading action and particularly, the trading action component-BuyOp 622 may be based upon changes in bank account, increase in number of Bitcoins, timestamps, etc. in the subscriber's account. Similarly, the trading action components—Buy Op 624 and the SellOp 626 may be based upon the details of the financial transaction data in between nodes in the protocol or workflow. The details may include changes in the assets sold or assets bought as described above.

In one embodiment, the requested financial report may include a favorable calculation of the subscriber's taxable income over the selling of the 20 Bitcoins in November 606. In this embodiment, the FTPC server 500 may link the AdjustOp 630 to each of the trading components—BuyOp 622, BuyOp 624, and SellOp 626 to adjust the cost basis for the BuyOp 622, BuyOp 624 and further adjust the proceeds for the SellOp 626. The linked AdjustOp 630 may belong, for example, to a particular action such as FeeAction that corresponds to calculation of transaction fees. With the adjusted cost basis and proceeds, the FTPC server 500 may then generate a first adjusted cost basis 640 based on a FIFO cost basis method, a second adjusted cost basis 650 based on a LIFO cost basis method, and/or a third adjusted cost basis 660 based upon specific identification. The specific identification may include preconfigured selection of an optimal or near-optimal assignment of asset location for every SellOp, for example.

Assuming that the fees associated with the BuyOp 624 and the SellOp 626 are the same (e.g., $100 amount of fees), the first adjusted cost basis 640 based on the FIFO cost basis method may be $500, which is derived from the cost of the 30 Bitcoins that were purchased on January 602 at $20 apiece plus the $100 fees (note that of the 30 Bitcoins purchased only 20 were sold, hence 20*$20+$100=$500). For the LIFO cost basis method, the second adjusted cost basis 650 may be $300 because the 20 Bitcoins were purchased on June 604 at $10 apiece and $100 fees are added to this purchase. Here, the FTPC server 104 may use the corresponding generated atomic primitive operations when calculating the first adjusted cost basis 640 and the second adjusted cost basis 650. For example, for the FIFO cost basis method, the FTPC server 104 may use the BuyOp 622 to be matched with the SellOp 626. For the LIFO cost basis method, the FTPC server 104 may use the BuyOp 624 to be matched with the SellOp 626.

Assuming that the cost basis generated by the FIFO cost basis method 640 is greater than the adjusted cost basis value that is generated by the use of the LIFO cost basis method 650, i.e., $500, then the FTPC server 500 may utilize the cost value of $500 as the cost basis for the sale 616 for the tax year 600 and thus, possibly reduce the tax liability of the subscriber.

### Example Implementation—Platform for Improving Cost Basis Calculation

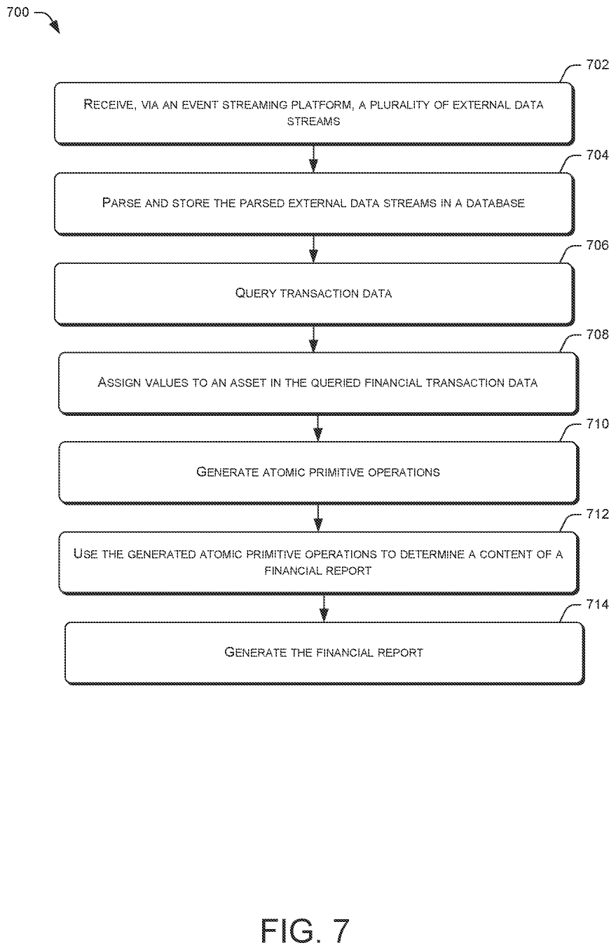

FIG. 7 is a flow diagram 700 that depicts an example process for at least one aspect of the techniques for improving a cost basis calculation based on atomic primitive operations. In the following discussion of FIG. 7, continuing reference is made to the elements and reference numerals shown in and described with respect to the FTPC server in conjunction with the smart contracts such as the smart contracts 182 of FIG. 1. Further, certain operations may be ascribed to particular system elements shown in previous figures. However, alternative implementations may execute certain operations in conjunction with or wholly within a different element or component of the system(s). Furthermore, to the extent that certain operations are described in a particular order, it is noted that some operations may be implemented in a different order to produce similar results.

At block 702, the FTPC server 500 may receive a plurality of external data streams from the external data 102. In one example, the queue 110 includes an event streaming platform that receives packets of external data streams encoded in JSON, XML or other structured data modeling language. The external data streams, for example, may include blockchain data 102(1), exchange exported data 102(2), customer supplied data 102(3), and/or external reference and meta data 102(4).

At block 704, the FTPC server 500 may parse and store the parsed external data streams in the database. For example, the data parser module 112 may transform the decoupled external data streams to conform with a schema structure of the database 554. In this example, the internal representation of the external data is stored in a particular format in the database 554.

At block 706, the FTPC server 500, via the data query module 540, may query and retrieve transaction data. In one embodiment, the FTPC server 500 may continuously query and retrieve the transaction data for processing. In a case where a particular transaction data is missing data, then the FTPC server 500 may use placeholders for additional data that can be requested from the subscriber. In another embodiment, the FTPC server 500 may query and retrieve the transaction data that correspond to the financial report notification alert to be forwarded to the subscriber. Here, the retrieved transaction data may include the actions that correspond to financial report notification alert to be transmitted to the subscriber. In various embodiments, the FTPC server 500 may query and retrieve the transaction data for processing based upon parameters of a received subscriber request. For example, the parameters may include, without limitation, the particular time period, type of transaction, subject of transaction, assets involved, or a combination thereof. In this example, the receiving of the subscriber request may trigger the querying and retrieving of the transaction data.

At block 708, the FTPC server 500, via the price value representation 542, may assign price values to the queried financial transaction data and particularly to the one or more assets that are involved in the action or blockchain-based financial transaction.

At block 710, the FTPC server 500 may generate atomic primitive operations. In one example, the FTPC server 500 may generate the atomic primitive operations that represent financial activity in the action based on the action's specified logic. In this example, the FTPC server 500 may store and associate the generated atomic primitive operations to the action.

At block 712, the FTPC server 500 may use the generated atomic primitive operations to determine the content of the financial report. For example, a matched pair of the generated atomic primitive operations (e.g., BuyOp and SellOp) may be used to generate a gross income for a particular traded asset.

At block 714, the FTPC server 500 may generate the financial report.

In one embodiment, the steps in the blocks 702-714 may generate events that can be received and processed by the smart contracts 182 of FIG. 1. Alternatively, or additionally, the steps in the blocks 702-714 may be facilitated by the smart contracts 182 in the DAO 180, which can centrally manage the FTPC server 500.

### Example Implementation—Selecting Adjusted Cost Basis Value

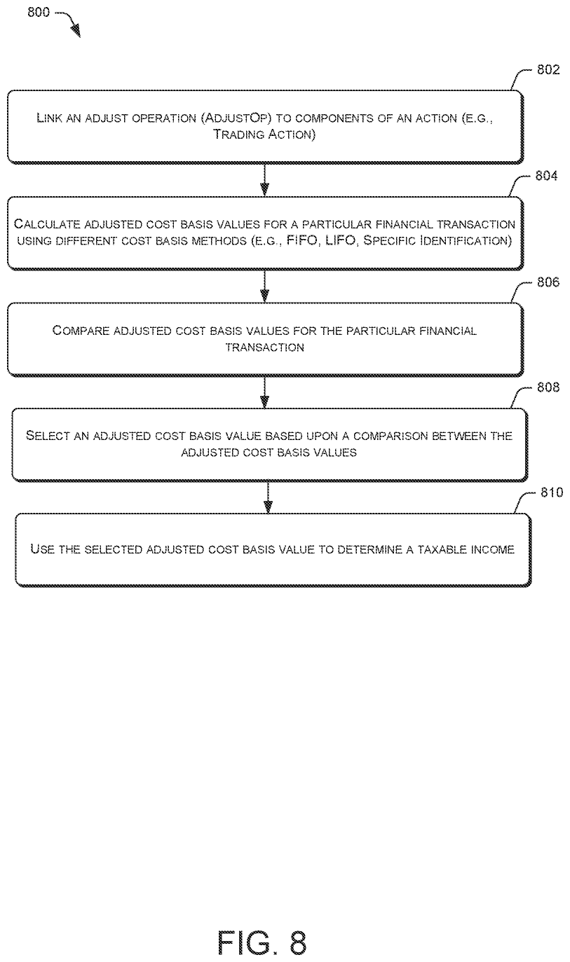

FIG. 8 is a flow diagram 800 that depicts an example procedure for at least one aspect of the techniques for selecting the adjusted cost basis value that can be used to determine, for example, a capital gain resulting from a transaction. In the following discussion of FIG. 8, continuing reference is made to the elements and reference numerals shown in and described with respect to the FTPC server in conjunction with smart contracts such as the smart contracts 182 of FIG. 1. Further, certain operations may be ascribed to particular system elements shown in previous figures. However, alternative implementations may execute certain operations in conjunction with or wholly within a different element or component of the system(s). Furthermore, to the extent that certain operations are described in a particular order, it is noted that some operations may be implemented in a different order to produce similar results.

At block 802, the FTPC server 500 may link an AdjustOp to components of an action. For example, the action is a trading action having BuyOp and SellOp components. In this example, the links between the BuyOps/SellOps (on one side) to the AdjustOps (on the other side) are many-to-many. A particular BuyOp or SellOp may be adjusted multiple times by linking the BuyOp or SellOp to multiple AdjustOps. In some cases, a single AdjustOp may adjust multiple BuyOps and/or SellOps.

At block 804, the FTPC server 500 may calculate adjusted cost basis values for a particular financial transaction using different cost basis methods. For example, the subscriber purchased 30 Bitcoins for $20 each plus $100 total fees, then later purchased 20 additional Bitcoins for $10 each plus $100 total fees. Assuming that the subscriber sold 20 Bitcoins at $25 each, then the calculated adjusted cost basis values for this particular transaction may be selected via one of the cost basis methods (e.g., FIFO, LIFO, or specific identification).

For example, using the FIFO cost basis method, the adjusted cost basis value for the sold 20 Bitcoins in the above example may include the amount of $20 per Bitcoin plus the $100 total fees for a total adjusted cost basis value of $500. Using the LIFO cost basis method, the total adjusted cost basis value for the sold 20 Bitcoins in the above example may include the amount of $10 per Bitcoin plus the $100 total fees for the total adjusted cost basis value of $300. A specific identification may be further utilized to select the location of the asset that can be associated with the adjusted cost value.

At block 806, the FTPC server 500 may compare the adjusted cost basis values between the different cost basis methods. In the preceding example, and assuming that the specific identification may generate an adjusted cost basis value that is lesser than the FIFO cost basis method, then the FIFO cost basis method may be utilized because of the higher amount ($500) of adjusted cost basis value versus the LIFO cost basis method ($300).

At block 808, the FTPC server 500 may select the adjusted cost basis value based upon the comparison between the adjusted cost basis values from the different cost basis methods.

At block 810, the FTPC server 500 may use the selected adjusted cost basis value on a gross income. The gross income for the particular transaction may be taken from the sale proceeds of an asset minus the adjusted cost basis of its acquisition.

In one embodiment, the blocks 802-810 may generate events that can be received and processed by the smart contracts 182 of FIG. 1. Alternatively, or additionally, the steps in the blocks 802-810 may be facilitated by the smart contracts 182 in the DAO 180, which can centrally manage the FTPC server 500.

### Example Implementation—DAO for Cost Basis Operations

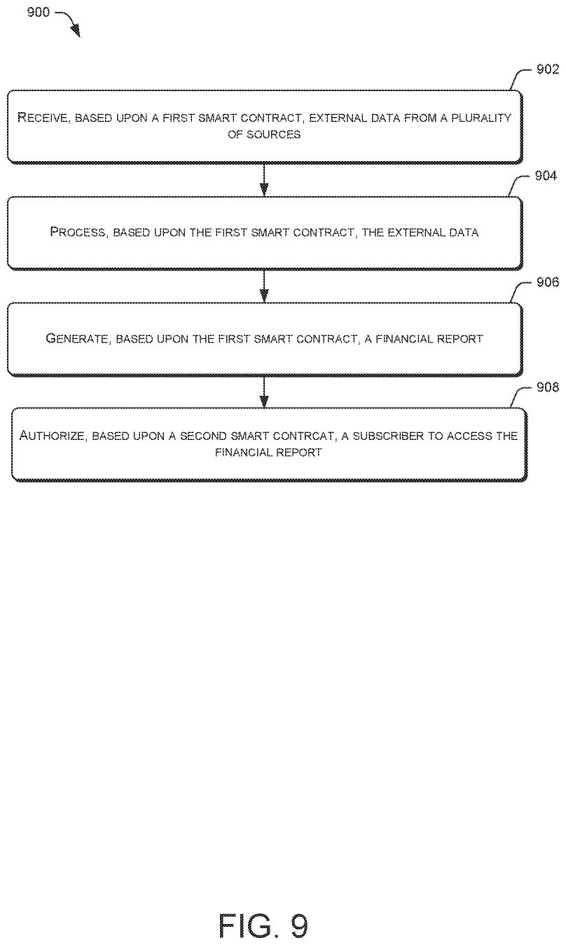

FIG. 9 is a flow diagram of an example procedure 900 for using the smart contracts to implement at least one aspect of the techniques for utilizing the DAO for cost basis operations. Particularly, one or more smart contracts may define receiving and filtering of external data, processing of the external data, and generating of content of the financial report as described in FIGS. 1-8. The procedure 900 will be described as being performed by the FTCP server 104 in conjunction with the smart contracts 182 in the DAO 180 of FIG. 1. In some implementations, the procedure 900 may be performed by the DAO 180 or other physical and/or virtual devices.

At block 902, the FTPC server 500, in accordance with, or via a first smart contract, may receive external data from a plurality of sources such as data from different exchanges, blockchain data, or customer supplied data. In one embodiment, the DAO 180 may use one or more smart contracts to implement the decentralized management of the operations of the FTPC server 500. Particularly, the decentralized management may include an ability of the FTPC server 500 to generate the content of the financial report based as described in FIGS. 1-8 above.

At block 904, the FTPC server 500, in accordance with, or via the first smart contract, may process the received external data. In one embodiment, one or more smart contracts may facilitate the receiving or filtering of the external data, storing an internal representation of the received external data to the database, and processing of the external data including generating one or more atomic primitive operations from at least one action to determine a content of a financial report. The one or more smart contracts may further facilitate the generating of the financial report using matching algorithms on the atomic primitive operations, where the financial report can be stored in a blockchain such as the blockchain platform 190 of FIG. 1.

At block 906, the FTPC server 500, in accordance with, or via the first smart contract, may generate content of a financial report. For example, generating of the financial report may be implemented via decentralized management through the DAO smart contracts. Alternatively, or additionally, the first smart contract may receive events and process the received events to generate the content of the financial report.

At block 908, the FTPC server 500, in accordance with, or via a second smart contract, may authorize a subscriber to access the content of the financial report that can be stored in a blockchain. In one embodiment, the first smart contract and the second smart contract may include subscriber-approved DAO smart contracts for transactional cost basis calculation.

### CONCLUSION

Although the subject matter has been described in language specific to structural features and/or methodological acts, it is to be understood that the subject matter defined in the appended claims is not necessarily limited to the specific features or acts described. Rather. the specific features and acts are disclosed as exemplary forms of implementing the claims.

What is claimed is:

1. One or more non-transitory computer-readable storage media collectively storing computer-executable instructions that upon execution cause one or more computing devices to collectively perform acts comprising:
via a first smart contract:
storing an internal representation of external data to a database;
processing the external data including generating one or more atomic primitive operations from at least one action to determine a content of a financial report; and
generating the financial report using matching algorithms on the atomic primitive operations, wherein the financial report is stored in a blockchain; and
via a second smart contract:
authorizing a subscriber to access the stored financial report,
wherein the first smart contract and the second smart contract include subscriber-approved decentralized autonomous organization (DAO) smart contracts for transactional cost basis calculation.

2. The one or more non-transitory computer-readable storage media of claim 1, wherein, at the first smart contract, the external data includes a blockchain data, exchange exported data, or a customer supplied data.

3. The one or more non-transitory computer-readable storage media of claim 2, wherein, at the first smart contract, the external data are sourced from a plurality of subscribers that approve the DAO smart contracts.

4. The one or more non-transitory computer-readable storage media of claim 1, wherein, at the first smart contract, the internal representation includes a MongoDB format of the external data.

5. The one or more non-transitory computer-readable storage media of claim 1, wherein the acts further comprise: via the first smart contract, assigning a price to one or more assets that participated in the at least one action.

6. The one or more non-transitory computer-readable storage media of claim 5, wherein the assigning includes associating a value with the one or more assets based upon the price of the one or more assets at a time of the financial transaction.

7. The one or more non-transitory computer-readable storage media of claim 1, wherein the acts further comprise: via the second smart contract, preserving ownership of the financial report for the subscriber.

8. The one or more non-transitory computer-readable storage media of claim 1, wherein, at the first smart contract, the at least one action includes a trading action

9. The one or more non-transitory computer-readable storage media of claim 8, wherein, at the first smart contract, the generated atomic primitive operations include a buy operation (BuyOp) and a sell operation (SellOp).

10. The one or more non-transitory computer-readable storage media of claim 9, wherein the acts further comprise: via the first smart contract, linking an adjust operation (AdjustOp) to the atomic primitive operations of the trading action: calculating adjusted cost basis values for the trading action: comparing the adjusted cost basis values: selecting the adjusted cost value based at least upon the comparison between the adjusted cost values;
and using the selected adjusted cost value to determine a taxable income.

11. A computer-implemented method, comprising:
via a first smart contract:
storing an internal representation of external data to a database;
processing the external data including generating one or more atomic primitive operations from at least one action to determine a content of a financial report; and
generating the financial report using matching algorithms on the atomic primitive operations, wherein the financial report is stored in a blockchain; and
via a second smart contract:
authorizing a subscriber to access the stored financial report;
wherein the first smart contract and the second smart contract include subscriber-approved decentralized autonomous organization (DAO) smart contracts for transactional cost basis calculation.

12. The computer-implemented method of claim 11, wherein, at the first smart contract, the external data includes a blockchain data, exchange exported data, or a customer supplied data.

13. The computer-implemented method of claim 12, wherein, at the first smart contract, the external data are sourced from a plurality of subscribers that approve the DAO smart contracts.

14. The computer-implemented method of claim 11, wherein, at the first smart contract, the internal representation includes a MongoDB format of the external data.

15. The computer-implemented method of claim 11, wherein the acts further comprise: via the first smart contract, assigning a price to one or more assets that participated in the at least one action.

16. The computer-implemented method of claim 15, wherein the assigning includes associating a value with the one or more assets based upon the price of the one or more assets at a time of the financial transaction.

17. The computer-implemented method of claim 11, wherein the acts further comprise: via the second smart contract, preserving ownership of the financial report for the subscriber.

18. A computer system, comprising:
one or more processors; and
memory including a plurality of computer-executable instructions that are executable by the one or more processors to perform a plurality of actions, the plurality of actions comprising:
via a first smart contract:
storing received external data to a database;
processing the external data including generating one or more atomic primitive operations from at least one action to determine a content of a financial report; and
generating the financial report based on the atomic primitive operations, wherein the financial report is stored in a blockchain; and
via a second smart contract:
authorizing a subscriber to access the stored financial report,
wherein the first smart contract and the second smart contract include subscriber-approved decentralized autonomous organization (DAO) smart contracts for transactional cost basis calculation.

19. The computer system of claim 18, wherein, via the first smart contract, the storing of the external data includes storing a MongoDB or a like format of the external data.

20. The computer system of claim 18, wherein, at the first smart contract, the external data includes a blockchain data, exchange exported data, or a customer supplied data.
